(19) United States
(12) Patent Application Publication
(10) Pub. No.: US 2012/0323721 A1
(43) Pub. Date: Dec. 20, 2012

(54) Seller-Controlled Dynamic Product Auction

(76) Inventor: Mark C. Koivuniemi, Indianapolis, IN (US)

(21) Appl. No.: 13/493,107

(22) Filed: Jun. 11, 2012

Related U.S. Application Data
(60) Provisional application No. 61/496,992, filed on Jun. 14, 2011.

(51) Int. Cl. G06Q 30/08

(52) U.S. Cl. 705/26.3

(57) ABSTRACT

The present invention relates to a dynamic seller-controlled auction method, system and apparatus for selling products or services prior to, at, or after product launch, including when such product or service is otherwise in short supply. The auction allows participants to bid on a set of items during a specified time period. Participants can bid to reserve a particular item; however, if a higher bid is placed the reservation for such item will transfer to the higher bidder.

### FIELD OF THE INVENTION

The present invention relates generally to methods, systems and apparatus for selling products under the control of a seller including a product originator prior to, at, or after product launch.

### BACKGROUND

Generally, new products proceed to market by being conceived, research, developed, prototyped, and made ready for launch. Successful product launches involve positioning, sales channels, distribution, advertising and public relations. Synchronizing marketing activities with product development is critical for success. Among the key components included in a strong product launch are clearly defined sales objectives, marketing, advertising, and resources to track, monitor and account for execution. Launch milestones are also generally established around a variety of defined objectives including, for example, identification of necessary launch channels, the number of new products to be sold by a specific date, whether the product will be ready to launch at a national trade convention, placement of sufficient stocking orders with key distributors, and whether the product can be entrenched by a specified date. To accomplish these goals, companies typically break down every conceivable launch component and, where appropriate, identify customer databases. New product samples may be sent to industry and trade publication reviewers in order to create a strong demand, and market buzz or “hype” for the product. To establish the new product's identity in the marketplace, the core message is repeated over and over again.

Increasingly common in today's cyber-driven commercial environment are corporations that provide information to consumers over the internet in advance of a product launch in order to generate interest in the product and even to dissuade consumers from buying an alternative product currently on the market. The impact of such strategies often motivate early adopters to seek the product on the day it is released. This type of demand creation phenomenon can happen at any time during the lifecycle of a product including, for example, when a retail item is in short supply, whether it be the result of a product launch, the inability of the company to produce enough of an item in a timely fashion to meet customer demand, or because the company is intentionally creating product shortage to increase product demand.

Internet auction systems are known. US Patent Application Publication number US 2003/0126061 A1, discloses an auction system embodied within the environment of a digital communications network, e.g., the Internet, wherein a server computer system is operatively linkable for bi-directional communications with a plurality of remote terminals, each remote terminal being under the control of a user of the network. It functions as a stepped pricing method when a specified number of items are bid on at an asking price. When all items are bid on at that price, the next range of product is sold at an incremented rate of increase. It does not cover a live real-time auction nor does it address the issue of product scarcity or a pre-launch auction system.

U.S. Pat. No. 6,085,176 discloses a method and apparatus for creating a computerized market for used and collectible goods by use of a plurality of low-cost posting terminals and a market maker computer. This patent discloses the standard e-bay-style auction system used to find a specific item allowing users to place bids on the specific item.

US Patent Application Publication number US 2003/0126061 A1 and U.S. Pat. No. 6,085,176 are incorporated herein by reference.

A problem with current retail systems is that when there is a scarcity of a product, neither the original seller of the product or the product originator has the ability to dynamically price the item such that the end purchaser pays the value they are willing to pay to secure guaranteed product access in this “short market”. In today's market, dynamic pricing happens on an ad hoc or post hoc basis, for example, when someone having the product item from the original manufacturer/owner through standard purchasing routes sells or “flips” the item at an increased price. This happens, for example, with video game systems being purchased at retail and then resold on eBay for twice the amount originally paid, with the end purchaser paying much more than the retail price, and the producer of the product receiving none of the additional profit. Scalpers selling tickets to a sporting event or concert at inflated prices outside the gate or through a secondary agent, is another example of this problem. In the end, a large amount of revenue and profit is captured by re-sellers rather than by the original producer of the good or service being offered. Moreover, purchasers, e.g., early adopters, are inconvenienced by, for example, standing in long lines overnight in bad weather and are never guaranteed they will have access to the product they desire.

There remains a need for methods, systems, and apparatus for maximizing product originator profit, increasing hype around a product, and providing assured access to products by early adopters and others who desire to purchase a product or service in short supply.

### SUMMARY OF THE INVENTION

It is an object of the present invention to provide a dynamic product launch auction method, system, and/or apparatus for buyers and sellers of products and/or services in short supply.

It is another object of the present invention to provide a dynamic auction method, system and/or apparatus for buyers and sellers of products and/or services prior to launch, at launch, or after launch.

The present invention relates in one aspect to a dynamic auction method, system, and/or apparatus for selling products under the control of a seller who may be a product originator or retailer, prior to, during, or alter product launch. In one embodiment, the invention relates to a dynamic, seller-controlled auction method, system, and/or apparatus wherein a product or service is in short supply, or unavailable through primary sources such as retail outlets.

The auction method and system of the present invention is dynamic in that participants can continually bid on-a set number of items during a specified time period. Participants can bid to reserve a particular item; however, if a higher bid is placed for that item the existing reservation for the item will transfer to the higher bidder.

In one aspect of the invention, the system is controlled by a seller through a neutral back-end database which can be used to interact with multiple front-end applications in real time to track user bids and manage the auction as it proceeds.

### BRIEF DESCRIPTION OF TIM DRAWINGS

FIG. 1 is block representation of an embodiment of a product launch auction system according to the present invention.

FIG. 2 is a schematic flow chart of an embodiment of one aspect of the present invention relating to a dynamic queue of items offered during an auction.

FIG. 3 illustrates a block schematic diagram of an exemplary computing system in accordance with one embodiment of the present invention.

### DETAILED DESCRIPTION OF THE PREFERRED EMBODIMENTS

As used herein, the term “seller” encompasses the generally held definition of the party that provides a good or service in a commercial transaction. “Seller” also refers to a product originator or original seller of a good or service. “Seller” may also refer to a product manufacturer or retailer.

As used herein, the term “product originator” refers generally to the first producer of a good or service including, for example, innovators, manufacturers, developers. Product originator may or may not include a retailer selling such products produced by the originator.

As used herein, the phrase “product launch auction” refers to an auction in which a seller offers its products or services to purchases including the general public.

As used herein, the term “reserve” or “reserved” refers to a status of an item that has been successfully bid on and thereby identified with a specific user/bidder. The “reserve” status temporarily or permanently removes an item from open bidding. The status of an item according to the invention is dynamic and may change during the course of an auction as price increases and as the identification of a user/bidder changes during the course of the auction.

As used herein the term “short-sale” or “short supply” generally refers to a situation in which demand for a product or service is high and/or demand exceeds ready availability and/or supply of a desired good or service.

In one aspect, the present invention relates to product launch auctions in which a seller, manufacturer, or retailer, or service provider offers its products or services to purchasers, generally to the retail public. In another aspect, the present invention also relates to any short-sale situation where a seller has a limited inventory for sale.

Accordingly, in one aspect, the present invention relates to an auction method, system, and/or apparatus preferably implemented by a programmed computer, which is controlled by a seller who may be a product innovator, originator, manufacturer, or retailer. The method of the present invention includes a pre-established time duration during which bidders may bid on specifically identified products. In some embodiments of the invention, a fixed number of products are offered, before, at, or after a product is launched. During this set time frame, bidders may compete for the items in real-time by bidding in a pre-determined pricing increment scheme. Bidders may purchase an item by having an item secured at the final base price for the product launch auction or by submitting a bid that exceeds the overall bid level of the rest of the products in the product launch auction.

In another aspect of the invention, bidders are able during the bidding period to track in real time what the going base price of the item is, as well as the status of their current bids. For Example, if a set of items is up for bid with an original base price of $500 and the predetermined minimum bid increment is set at $5, bidders will be able to either bid at the base price, or a multiple of the increment price. If all items have bids at the base price or higher, the base price will increase incrementally to $505 for any bidder who wishes to join the product launch auction. A bidder will be able to displace a previous bidder and secure the item at the new price by placing a $505 dollar bid and so on for the entirety of the bidding period. If the primary concern of the bidder is simply to have access to the product or service, e.g., an early adopter, they can bid much higher at their discretion. Bidders are not required to continue actively in the auction until all bids have passed their bid amount. Bidders will be notified when their bid is beaten in order to encourage further bidding competition. To encourage a bidding “frenzy” a countdown timer may be displayed to each bidder during the further product launch auction. Additionally, words or phrases associated with auctions, such as “going, going, gone”, may be displayed on the computer screen and/or audibly available to the live and online bidders. This will continue until the end of the predetermined bidding period.

In one embodiment, the present invention relates to a method of selling products under control of the product originator prior to, during, or after product launch, or if such product is otherwise in short supply. In a preferred embodiment, the present invention is directed to a computer-based sales auction process comprised of the steps of: establishing communications over a network between an auctioneer's database and a plurality of bidding interfaces; providing information regarding the products to be sold to potential bidders; and submitting at least one bid via the bidder's interface. Information that may be made available to bidders during an auction include, for example, the current required bid, the identity of a bidder, the status of a plurality of bidders, and bid status on a portion or all of the product inventory available.

In one embodiment, the process of the present invention is preferably performed by a programmed computer configured to perform the steps of the invention. Accordingly, in one aspect, the steps of the present invention are recorded in digital form on any media capable of storing an instruction set. By providing that instruction set to a general purpose computer, the general purpose computer is then configured to perform the instructions, and practice the steps of the present invention. As will be recognized by those having skill in the art, the function of any computer programmed by software to perform any series of steps, including the steps of the present invention, can also be accomplished by configuring computer hardware to perform the identical steps. Further, a computer capable of multiple configurations can be designated as a single purpose computer, dedicated to performing only one task, simply by providing the computer only one software application. Accordingly, the present invention should also be understood to include any computer system, whether multipurpose or single purpose, that has been configured to perform the steps described herein, whether as a series of steps provided to the computer as software, or by configuring the computer's hardware to perform the series of steps described and claimed herein.

The following description relates to and exemplifies a preferred embodiment of the dynamic method and system of the present invention.

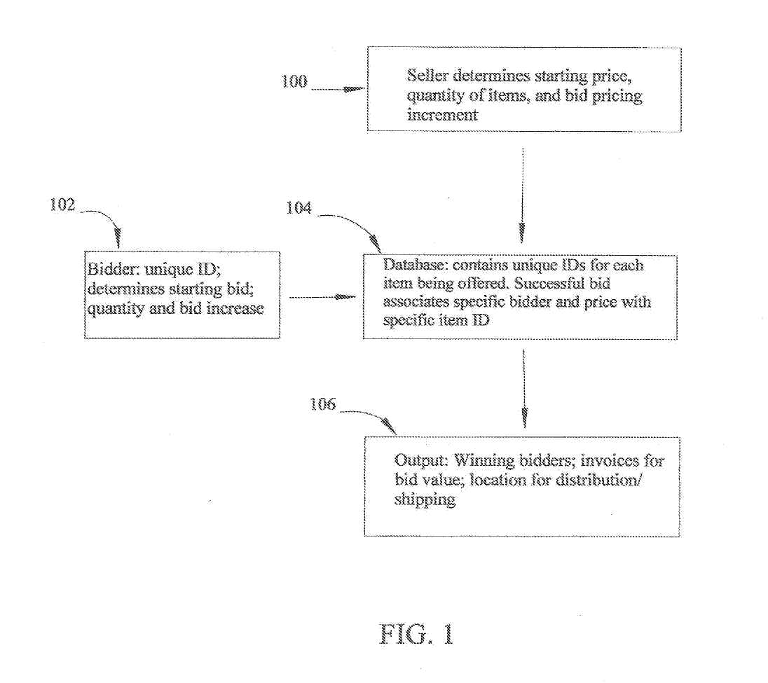

FIG. 1 illustrates generally some aspects of the method/system of the present invention. A seller offers a fixed number of items for sale, setting a starting price and minimal bid increment 100. Bidders are provided with a unique identifier which could be based on any alpha-numeric or other coding method by which the method/system can track the bids placed and bid increases 102. Items up for bid are also associated with a unique identifier. A data base 104 keeps track of bids, bidders and items, and associates successful bidders with specific items at a particular price. At the close of the auction the method/system provides an output 106 that can include, for example, the identity of successful bidders, invoices for items sold, and a location for distribution and/or shipping of sold items.

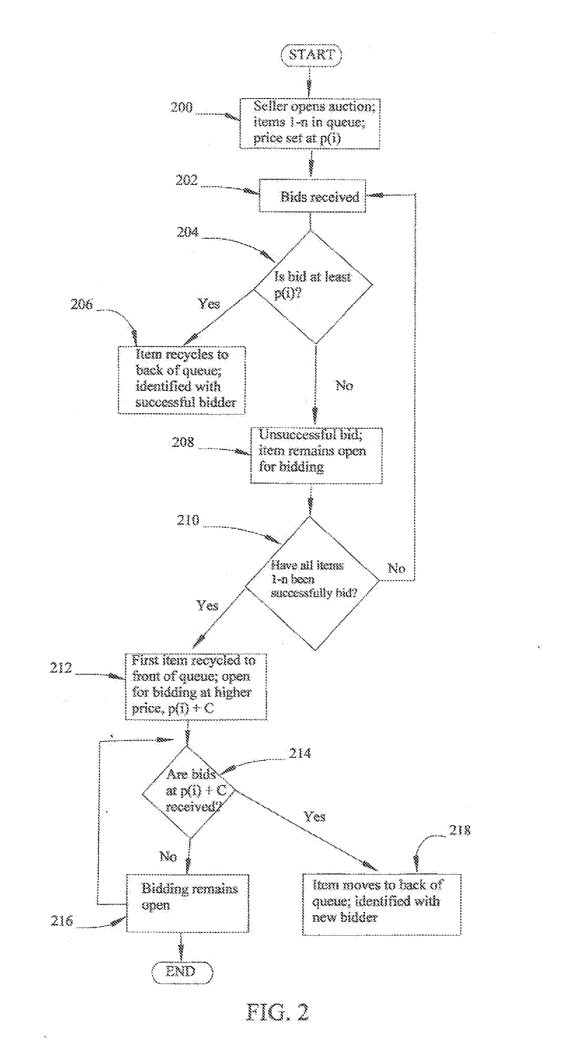

A pool of a fixed number of items is put up for auction by a seller; preferably the auction is implemented over a computer network that links sellers and bidders. As illustrated in FIG. 2, in one embodiment, the method/system creates a dynamic queue of items 200, the status of which can change over the course of the auction. For example, whether a particular item x(i) is available for bid is tracked. Availability of an item for bidding depends on whether anyone has successfully bid on the item. Bids are received 202 and if the bid is at least the asking price p(i) 204 it changes status. An item x(i) that has been successfully bid on, and thereby attached or identified with a specific bidder, moves to the back of the queue 206. If a bid is unsuccessful, for example, not at least at the asking price p(i), then the item remains open for bidding 208. With continued bidding, items cycle through the queue 210, and can eventually be up for bid again at a higher price 212.

The place or position of item x(i) in the queue is also tracked. Once an item is successfully bid on, it goes to the back of the queue, thereafter moving incrementally forward in the queue as other items in the queue are successfully bid on. Thus, the incipient right to purchase an item achieved by early successful bidders is preserved by restricting the availability of items already successfully bid on from further bidding by new bidders unless and until the entire queue rotates one cycle, and a new higher bid is received. An item can advance position in the queue over time (i.e. move further toward the front of the queue), depending for example on the activity of the auction, i.e. how desirable it is by new bidders. When all items in the queue are successfully bid on, a full cycle is completed and the first item successfully bid on will be back at the front of the queue 212. If a new, higher bid p(i)+C is received on a previously successfully bid item 214, that item will now have its identity associated with the new bidder, and once again rotate to the rear of the queue 218.

The seller sets an initial asking price for the items in the queue. Once all items are identified with successful bidders the auction can continue by receiving new bids that are some increment C higher than the one or more earlier successful bid(s) received on it. In that case, an item can transition its position in the queue and its association with a particular successful bidder. This aspect contributes to the dynamic feature of the system and to efficiency for a seller to sell a fixed number of items at an optimized price.

In one aspect, the method/system of the invention identifies or associates a particular item with a successful bidder. In a preferred embodiment, the method/system comprises a data base to keep track of bidder identity; specific items in the queue; and the identification of items associated with particular successful bidders;

In another aspect the present method/system may include dynamic modeling and/or graphical tools to graph, visualize, or otherwise represent the data of the auction including the status of each item as it proceeds through the auction in real-time; how the bid price changes; the identity/contact information of successful bidder identity, etc. Such information may be provided in real-time to the seller as an indicator of the potential for overall success of the product in the marketplace.

in one embodiment, a seller, for example, a retailer has X number of product items that will be available for sale at a specified date. A time period is established as a pre-order window during which the units will be available for bidding. Bids are handled through a centralized database in which each individual product unit or item is assigned a unique identifier.

When a bidder places a bid on an item at an available price, the bidder's identifier information is placed in a structured database along with the bid price for the particular item. The particular item is then cycled to the back of the bidding queue. While a queue structure is preferred, any suitable data structure can be used to achieve this effect including, but not limited to, arrays, lists, linked lists, stacks, queues, and binary trees.

According to one embodiment of the invention, a bidding queue operates by a process as generally illustrated in FIG. 2. Starting with all items set at a base price P(i), each item is made available for bid. A user of the product launch auction according to the present invention has two options when placing a bid: 1) Bid at the current price for the item, or 2) place a bid higher than the current price that is a multiple of a pre-determined increment, C, for bidding, e.g., base price for an item is set at $100 with a bidding increment of $5; all bids must be 100+5(Z) where Z is an integer (0, 1, 2 . . . n). If a bid is received that is higher than the current price for any particular item at the time of the bid, the status of the item is changed from being open for bid at the current price to being closed for bid at the current price. This removes the item from the available pool of items unless and until the bidding price for all items reaches that amount in which case the item will become the first item available for bid once again. The bidder can bid any incremental amount at his discretion. For example, if the original price is $100 and the bidder bids $500 for the item, the bidder will be secure in his purchase until and unless the bids for all items available surpasses $500.

The pool of items will operate such that when a user places a minimum bid, their particular item will move to the back of the bidding queue and cycle forward as bidding continues and the bid price rises.

When all items have a bid placed on them, the base price may increase incrementally by a pre-established increment “C” set by the seller. When a bidder places a bid at the increased price, he bumps the original bidder from the item (or any other bidder as determined by the Seller) and the new bidder will have the item linked to their name and price at the back of the queue. If the minimum bid is not met, the Seller can cut back on the amount or number of items available, change the minimum bid, cancel the auction, or otherwise take action to control the progress of the auction.

In order to encourage further bidding and fairness, a bidder can opt to be notified by e-mail, sms message, or other communication as to the status of his bid. In this way, the bidder will know that he no longer has an item reserved and must place a new bid at a higher price in order to secure the product in the auction.

At the end of the product launch auction period, all items will be locked in and identified with a price and bidder. Optionally, the method and system of the invention may include additional data with each item including, for example, the desired method of delivery, whether it be through a retail service, e.g., a physical store, or through direct shipping to the customer.

Product originators have the option to determine how many items will be made available through each delivery system or simply allow the bidding market to determine delivery for them.

In one aspect, the system of the invention comprises a database that associates a user/bidder with a unique item, and cycles the pool of available items and prices according to the process set forth herein.

Bids can be transmitted to the database by various communication systems in real time known to the skilled artisan, and the database can be used to display the current price of an item, gather the bidder's payment information and preferred delivery method, and allow a bidder to place a bid at the current price or an incrementally higher price. This can be done via an application on a mobile operating system such as an Android, Iphone, WebOS, Blackberry, Windows Phone 7, or through a website or web application, WAN, LAN, SAN, wireless network, intranet, internet, peer-to-peer network, etc. Customers/bidders can, optionally, go through a physical retail outlet and have the outlet place the order in the database for them. The input system simply needs to be able to send and receive information in a secure manner to and from the database.

In one embodiment, the product launch auction is conducted by an auctioneer, either hired by the seller to solicit and receive bids, or by the seller itself (together “auctioneer”). In a preferred embodiment, the auctioneer uses a computer/server connected to a network such as the Internet. The auctioneer maintains a database that may be accessed by users. As used herein, the term “user” means any person who accesses the auctioneer's web site, including the auctioneer, bidder, seller, originator, manufacturer or auction administrator. In a preferred embodiment, users interact with applications made available by the auctioneer to connect to and interact with the product launch auction database. Such applications can be implemented either entirely in the form of hardware or entirely in the form of software, or a combination thereof which are executed to perform processes of the present invention.

In one embodiment, the user is presented with an application which is able to communicate with the auctioneer's database. This database will reside entirely on the auctioneer's computer and is managed by a database management system such as, but not limited to, MySQL. Bidders communicate with the database via an application including, but not limited to, a mobile operating system including, for example, Android, phone, WebOS, Blackberry, Windows Phone 7, or through the internet, a website or web application.

In a preferred embodiment, each user must either register or make arrangements in advance with the auctioneer to receive an identification number (“ID”) to obtain access to product launch auction information, and to enter or review bids. In one embodiment, the user must agree to terms of use as well as submit billing information to pay for any winning bid.

A user selects an upcoming or current product launch auction at a selections page and is directed through a current auctions branch to a login page. To enter a product launch auction, the user must first acknowledge that the user is eligible to bid. If the user indicates that the user is not eligible, then the user is returned to the start page. Selection of the “eligible” option causes the product(s) available for bid to be displayed.

A “rules of auction” link may be provided stipulating the rules and conventions that all bidders must acknowledge or agree to when participating in the product launch auction. The rules may also explain how disputes, if any, will be resolved, how bids are sequenced and processed and how purchase amounts may be altered after the auction to accommodate re-queuing.

A log-in page is provided to ensure that a user is identified and validated as legitimate. It requires the user, as a condition to entering the specific product launch auction chosen, to enter his unique identification number (ID) assigned by the auctioneer and his password, which is predetermined by the user. This ID will be used to store billing/shipping information as well as function as the identity which will be attached to an item during bidding and upon execution of a successful bid.

The selected bid information is predetermined by the seller prior to the product launch auction and is updated continuously throughout the auction by displaying a current required bid. Any other appropriate information relating to the bids or the auction may also be included.

All bids must be submitted before the product launch auction ends. The start time, end time and current time or time or last update may be shown on the bid preparation and submission page.

After a user selects the submit button and the bid is verified as conforming to the bid parameters, the bidder is presented with a confirmation screen to confirm the bid prior to submission.

At the end of the product launch auction, all winning bidders receive confirmation of their winning bids and purchased items, for example, by email. A successful bidder may also receive additional confirmation after the Seller has made the final distribution.

In another aspect, the invention includes a bidders log containing a record of every bid submitted by every bidder during an auction. It identifies the bidder, the bidder's ID number and password entered by the bidder, the responses by that bidder to the questions on the verification page and the entries made by the bidder which were submitted as bids, whether winning bids or not.

Users may receive confirmation automatically on the occurrence of selected events. For example, when a registered bidder enters his ID number and password, an e-mail confirmation is immediately sent to confirm the fact that he has entered an auction. If, for example an impostor somehow succeeds in impersonating a bidder, the bidder will receive an e-mail showing that the auctioneer believes the bidder has entered the auction. This serves as a cross-check for security purposes.

Certain aspects and embodiments of the invention provide the seller with options for customization. For example, a seller may adjust the amount of product made available for auction. If a product is selling below the desired level, the seller can reduce the supply to create a sense of scarcity and increased demand or “hype” around the product.

A seller may also determine the bidding increment and base price. Through these variables the seller can control pricing, increasing or decreasing the price to induce more or fewer rounds of bidding.

A seller can also control the input method. The seller can have simple custom inputs embedded in pre-existing mobile/web/retail applications which allow bidders to track their bid and create new bids.

In one embodiment, the system/method of the invention allows customers to see their spot in the bidding queue allowing the bidder to determine velocity of bidding and how often they will have to re-bid if they want to stay at the lowest bid level.

In another aspect, a seller can use different output methods. Sellers can gather data on the desired method of delivery of a product item to the buyer, e.g., direct delivery or by pick up at a specified retail location, thereby eliminating inefficiencies in predicting how many units to deploy through various physical/internet retail distribution outlets.

In another aspect, the database can be modified and hosted via specified encryption methods so sellers and other users can be assured of data security.

In another aspect, the system/method of the invention includes control specific bidding groups. For example, certain sections of seating in a stadium, or concert hall could be bid on separately to determine pricing for a seating area instead of a simple system covering all seats in the stadium or hall.

An object of this invention is to eliminate economic inefficiencies by allowing sellers and bidders to determine pricing of items including products and services such as, but not limited to, retail electronics, video games, software, event ticket sales, etc. through bidding, thus creating hype for the item, useful marketing information, access to products for bidders and increased profit for the Seller. Customers derive benefit by having access to products/services/events at the prices they are willing to pay as determined by the market and will be assured that they will have access to a product, for example, at the product launch. Sellers have control regarding how the bidding is conducted as well as how distribution methods are chosen. In addition, sellers have access to user information as to where bids were submitted from and through what method as well as how often a user bids on each item and what types of items a user typically bids on. In other words, the seller will gather data which can be mined to determine future pricing schemes or product directions.

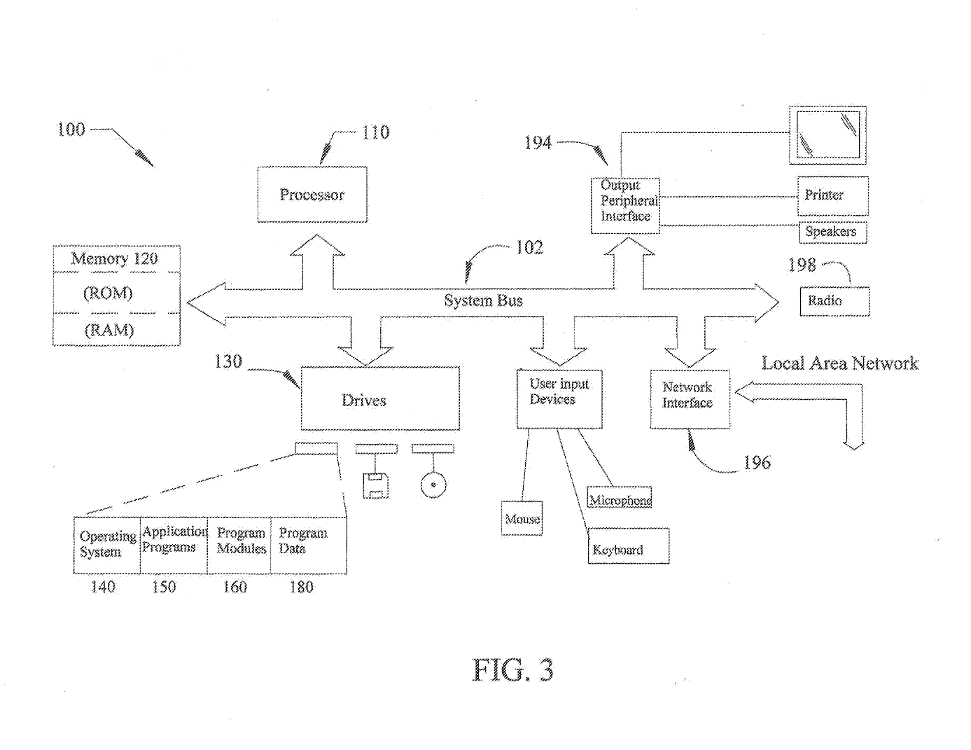

With reference now to FIG. 3, depicted is an exemplary computing system for implementing embodiments of the invention. FIG. 3 includes a computer 100, which could be any one of a remote device 200 or local device 300. Computer 100 may be a portable device, wherein at least some or all of its components are formed together in a single device which can be carried around by a person. The computer 100 includes a processor 110, memory 120 and one or more drives 130. The drives 130 and their associated computer storage media provide storage of computer readable instructions, data structures, program modules and other data for the computer 100. Drives 130 can include an operating system 140, application programs 150, program modules 160, and program data 180. Computer 100 further includes input devices 190 through which data may enter the computer 100, either automatically or by a user who enters commands and data. Input devices 190 can include an electronic digitizer, a microphone, a camera, a video camera, a keyboard and a pointing device, commonly referred to as a mouse, trackball or touch pad. Other input devices may include a joystick, game pad, satellite dish, scanner, and the like. In one or more embodiments, input devices 190 are portable devices that can direct display or instantiation of applications running on processor 110.

These and other input devices 190 can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers and/or display devices, which may be connected through an output peripheral interface 194 and the like.

Computer 100 also includes a radio 198 for wirelessly transmitting and receiving data for the computer 100 with the aid of an antenna. Radio 198 may wirelessly transmit and receive data using WiMAX™, 802.11a/b/g/n, Bluetooth™, 2G, 2.5G, 3G, and 4G, wireless standards.

Computer 100 may operate in a networked environment using logical connections to one or more remote computers, such as a remote computer. The remote computer may be a personal computer, a server, a router, a network PC, a peer device or other common network node, and may include many if not all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN to environments such as the Internet. It will be appreciated that other means of establishing a communications link between the computers may be used.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof; and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents. Those having ordinary skill in the art will recognize that the steps described both in this description and in the claims may be performed in an order different than that which is presented, and that performing the steps in an alternative order to accomplish the same end result is within the scope of the invention.

What is claimed is:

1. A computer-implemented process for auctioning items comprising:
a. providing at least one server computer in communication with a computer network;
b. offering for sale in a first round offering a fixed number of items, said items comprising a queue, wherein said offering is at an offering price Pᵢ, wherein each of said items in said queue have a status of being open for bidding at Pi or closed for bidding at Pi;
c. providing a unique identifier for each of the items;
d. receiving a bid on an item from an initial bidder on that item of at least Pᵢ; and
e. associating said item with an identifier of said bidder;
wherein said associating step e causes the status of said item to change from open for bidding at Pi to closed for bidding at Pi.

2. A process as in claim 1 wherein after each of said items has been associated with a bidder and is closed for bidding at Pi, said process further comprising one or more additional rounds of bidding wherein said items are offered at a price Pi+C, wherein C is a price increase increment set by the seller, and wherein receiving a bid on an item from a subsequent bidder at said price Pi+C causes said item to become associated with the identifier of said subsequent bidder.

3. A system for performing an auction of items comprising a server computer hosting the steps of claim 1, wherein said server is accessible via a computer network by at least one client computer, and wherein said server provides a user interface whereby a bidder can review items up for sale and place a bid.

4. A computer-implemented process for auctioning items as in claim 1 further comprising providing a Web site hosted by at least one computer in communication with said computer network.

5. A process as in claim 1 wherein said items are products are in short supply, and said auctioning of such products is through a product originator-controlled database.

6. A process as in claim 1, wherein said items are products and said process is held before product launch.

7. A system as in claim 3 further comprising a database which (a) tracks which bidder is attached to a unique item in said queue of available items for sale in the auction and (b) cycles through the pool of said available items and prices them.

8. A computer-based auction process comprising the steps of:
making available for sale a fixed number of items;
establishing a time period during which the product will be available for bidding;
receiving bids through a centralized database in which each individual item is assigned a unique identifier;
cycling an item through a bidding queue to the back of the queue when a bidder places a bid on an item at a currently available price.

9. The process of claim 8 wherein said cycling step further comprises:
a. setting a base price P(i) for all items available for bid;
b. receiving from a bidder a bid at the currently available price for an item, or a bid higher than the currently available price that is a multiple of a pre-determined increment for bidding;
c. removing an item from the pool of available items if the bid is higher than the current price of the item at the bid time, unless the bidding price reaches the price of that item, in which case it will become the first available item for bidding once again;
d. increasing the hid price incrementally by the pre-established increment C when all items have a bid of at least Pi placed on them;
e. replacing the original bidder for an item with a second bidder when the second bidder places a bid at a higher price and linking the item to the second bidder and price and sending the bid to the back of the queue; and
f. locking in price and bidder and, optionally, their desired method of delivery.

10. In an electronic auction system including a seller's computer having a seller-controlled database and at least one bidder's computer having an input device and a display, said bidder's computer being located remotely from said seller's computer, said computers being coupled to at least one electronic network for communicating data messages between said computers, an electronic auctioning process for auctioning retail items and services comprising:
a. inputting data associated with at least one bid for at least one item into said bidder's computer via said input device;
b. submitting said bid by transmitting at least some of said inputted data from said bidder's interface over said at least one electronic network;
c. communicating at least one message associated with said submitted bid to said seller's computer over said at least one electronic network; and
d. displaying, on said seller's computer display, information associated with said bid including said computed interest cost value,
wherein at least one of the inputting step, the submitting step, the communicating step and the displaying step is performed using a database interface controlled by the originator of said product or service.
